(19) United States
(12) Patent Application Publication
(10) Pub. No.: US 2012/0202041 A1
(43) Pub. Date: Aug. 9, 2012

(54) MULTILAYER LIGNOCELLULOSE-CONTAINING MOLDINGS HAVING LOW FORMALDEHYDE EMISSION

(75) Inventors: Daniel Käsmayr, Ludwigshafen (DE); Konrad Roschmann, Landenburg (DE); Michael Schmidt, Dudenhofen (DE); Michael Finkenauer, Worms (DE); Michael Kalbe, Weinheim (DE); Stephan Weinkötz, Neustadt (DE)

(73) Assignee: BASF SE, Ludwigshafen (DE)

(21) Appl. No.: 13/313,598

(22) Filed: Dec. 7, 2011

Related U.S. Application Data
(60) Provisional application No. 61/424,072, filed on Dec. 17, 2010.

(51) Int. Cl. B32B 21/02; B29C 67/24

(52) U.S. Cl. 428/313.5; 264/113

(57) ABSTRACT

The invention relates to a multilayer lignocellulose-containing molding. The molding contains a middle layer or a plurality of middle layers containing lignocellulose-containing particles which are obtainable by using a binder and a covering layer or a plurality of covering layers containing lignocellulose-containing particles which are obtainable by using a binder. At least one middle layer contains expanded plastic particles.

### CROSS-REFERENCE TO RELATED APPLICATIONS

This application claims benefit (under 35 USC 119(e)) of U.S. Provisional Application 61/424,072, filed Dec. 17, 2010 which is incorporated by reference.

### BACKGROUND OF THE INVENTION

The present invention relates to a multilayer lignocellulose-containing molding as defined in the claims.

Furthermore, the present invention relates to a process for the production of a multilayer lignocellulose-containing molding and the use of a multilayer lignocellulose-containing molding for the production of articles of all types and in the construction sector and for the production of pieces of furniture and furniture parts, of packaging materials, in house building or in interior finishing or in motor vehicles.

Materials based on lignocellulose are known. Important examples of lignocellulose-containing materials are wood parts, such as wood layers, wood strips, wood chips or wood fibers, it being possible for the wood fibers, optionally, also to originate from wood fiber-containing plants, such as flax, hemp, sunflowers, Jerusalem artichoke or rape. Starting materials for such wood parts or wood particles are usually timbers from the thinning of forests, residual industrial timbers and used timbers and wood fiber-containing plants.

The processing to give the desired lignocellulose-containing materials, such as wood particles, is effected by known processes, cf. for example M. Dunky, P. Niemt, Holzwerkstoffe and Leime, pages 91-156, Springer Verlag Heidelberg, 2002.

Lignocellulose-containing moldings, also referred to as woodbase materials here in the case of wood as lignocellulose, are an economical and resource-protecting alternative to solid wood and have become very important, particularly in furniture construction and as building materials. As a rule, wood layers of different thickness, wood strips, wood chips or wood fibers of various timbers serve as starting materials for woodbase materials. Such wood parts or wood particles are usually pressed at elevated temperature with natural and/or synthetic binders and, optionally, with addition of further additives to give board-like or strand-like woodbase materials. Examples of such lignocellulose-containing moldings or woodbase materials are medium density fiber boards (MDF), wood particle materials, such as particle boards and oriented strand boards (OSB), plywood, such as veneered plywood, and glued wood.

Binders used are as a rule formaldehyde-containing binders, for example urea-formaldehyde resins or melamine-containing urea-formaldehyde resins. The resins are prepared by polycondensation of formaldehyde with urea and/or melamine. The use of such formaldehyde resins can lead to the presence of free formaldehyde in the finished woodbase material. By hydrolysis of the polycondensates, additional formaldehyde may be liberated. The free formaldehyde present in the woodbase material and the formaldehyde liberated by hydrolysis during the life of the woodbase material can be released to the environment.

Above certain limits, formaldehyde can cause allergies and irritation of the skin, respiratory tract and eyes in humans. The reduction of the formaldehyde emission in components, especially in the interior sector, is therefore an important challenge.

The prior art discloses the following measures for reducing or suppressing the formaldehyde emission from woodbase materials:
use of aminoplast glues which were prepared with little formaldehyde
addition of formaldehyde scavengers to the aminoplast glue, for example urea and/or melamine
aftertreatment of the finished woodbase materials with so-called formaldehyde scavengers, such as compounds comprising amine groups

However, such measures are still not completely satisfactory. The preparation of the aminoplast glues with little formaldehyde or the addition of formaldehyde scavengers to the aminoplast glue leads to the glue curing more slowly, which increases the residence times in the hot press and thus adversely affects the cost-efficiency of the production of the woodbase material.

WO 2010/031718 A1 (BASF SE) describes a multilayer lignocellulose-containing molding comprising a middle layer and a covering layer in which the binder for the middle layer is formaldehyde resin and/or organic isocyanate and the binder for the covering layer comprises a (co)polymer of ethylenically unsaturated carboxylic acids with further ethylenically unsaturated monomers and, under certain preconditions, a formaldehyde scavenger. WO 2010/031718 A1 does not disclose an organic isocyanate as a component of the binder for the covering layer.

WO 2008/046892 A2 (BASF SE) describes a light wood-containing material comprising wood particles, a filler from foamed or foamable plastic particles and binder, and also a multilayered woodbase material comprising the light wood-containing material mentioned. WO 2008/046892 A2 does not disclose the binder b) as per the present application.

WO 2009/037240 A2 (BASF SE) describes a light wood-containing material comprising wood particles, a filler from foamed or foamable plastic particles and a binder from aminoplast resin and organic isocyanate, and also a multilayered woodbase material comprising the light wood-containing material mentioned. WO 2009/037240 A2 does not disclose the binder b) as per the present application.

The multilayer moldings described in the prior art still leave room for improvements with respect to mechanical strengths (for example transverse tensile strength, peeling strength of the layers according to the corresponding test standard mentioned in the examples) and also moisture resistance (for example 24 hour swelling or water absorption according to the test standard or test prescription mentioned in the examples).

### A SUMMARY OF THE INVENTION

The object of the present invention is accordingly to overcome the disadvantages described in the prior art. In particular, it was intended to provide multilayer lignocellulose-containing moldings whose formaldehyde emission was to be reduced or virtually absent, and the multilayer lignocellulose-containing moldings being intended to have good mechanical properties, in particular with relatively low specific weight.

The object was achieved by a multilayer lignocellulose-containing molding comprising
A) a middle layer or a plurality of middle layers comprising lignocellulose-containing particles which is/are obtainable by using a binder (a) and
B) a covering layer or a plurality of covering layers containing lignocellulose-containing particles which is/are obtainable by using a binder (b),
   the binder (a) being selected from the group consisting of (a1) formaldehyde resins and (a2) an organic isocyanate having at least two isocyanate groups;
   the binder (b) comprising the following components:
   an aqueous component (I) comprising
   (i) a polymer A which is composed of the following monomers:
   a) from 80 to 100% by weight of at least one ethylenically unsaturated mono- and/or dicarboxylic acid (monomer(s) A1) and
   b) from 0 to 20% of at least one further ethylenically unsaturated monomer which differs from the monomers A1 (monomer(s) A2)
   optionally
   (ii) a low molecular weight crosslinking agent having at least two functional groups which are selected from the group consisting of hydroxyl, carboxyl and derivatives thereof, primary, secondary and tertiary amine, epoxy, aldehyde,
   an organic isocyanate having at least two isocyanate groups as component (II)
   and, optionally, a component (III), as an aqueous dispersion, comprising one or more polymer(s) M which is/are composed of the following monomers:
   a) from 0 to 50% by weight of at least one ethylenically unsaturated monomer which comprises at least one epoxide and/or at least one hydroxyalkyl group (monomer(s) M1) and
   b) from 50 to 100% by weight of at least one further ethylenically unsaturated monomer which differs from the monomers M1 (monomer(s) M2)
      and, optionally, customary additives as component (IV),
      and at least one middle layer A) comprising expanded plastic particles and, optionally, at least one covering layer B) comprising expanded plastic particles,
      and the binder (b) optionally comprises a formaldehyde scavenger.

### A DETAILED DESCRIPTION OF THE INVENTION

The term lignocellulose is known to the person skilled in the art. Important examples of lignocellulose are wood, bark, cork, bagasse, straw, flax, bamboo, alfa grass, rice shells, sisal fibers and coir fibers. The material can be present in the form of granules, strands, shavings, fibers or flour. Very suitable examples of lignocellulose-containing particles are wood parts, such as wood layers, wood strips, wood chips or wood fibers, it being possible for the wood fibers to originate, optionally, also from wood fiber-containing plants, such as flax, hemp, sunflowers, Jerusalem artichoke or rape.

Wood particles, flax particles, in particular wood fibers or wood chips, and flax fibers or flax chips, the latter generally being referred to as flax shives, are preferred as lignocellulose-containing particles.

The abovementioned lignocellulose in the abovementioned forms can naturally also be used in mixtures, for example mixtures of wood fibers with flax fibers or wood chips with flax shives.

The binder (a) comprises a formaldehyde resin, preferably aminoplast resin (a1) and/or an organic isocyanate having at least two isocyanate groups (a2).

If the binder (a) comprises an aminoplast resin, the binder (a) as a rule also comprises the substances known to the person skilled in the art, generally used for aminoplasts and usually designated as curing agents, such as ammonium-sulfate or ammonium-nitrate or inorganic or organic acids, for example sulfuric acid, formic acid, or acid-generating substances, such as aluminum chloride, aluminum sulfate, in each case in the customary, small amounts, for example in the range from 0.1% by weight to 6% by weight, based on the total amount of aminoplast resin in the binder (a).

A formaldehyde resin is understood here as meaning polycondensates of compounds having at least one carbamido group (the carbamido group also called a carboxamido group) optionally partly substituted by organic radicals and an aldehyde, preferably form aldehyde; these resins are also called aminoplast resins. Formaldehyde resins are furthermore understood herein as meaning phenol-formaldehyde resins (PF resins).

All formaldehyde resins known to the person skilled in the art, preferably those known for the production of woodbase materials, can be used as suitable formaldehyde resin.

Such resins and their preparation are described, for example, in Ullmanns Enzyklopädie der technischen Chemie, 4th, revised and extended edition, Verlag Chemie, 1973, pages 403 to 424 “Aminoplaste” and Ullmann's Encyclopedia of Industrial Chemistry, vol. A2, VCH Verlagsgesellschaft, 1985, pages 115 to 141 “Amino Resins” and in M. Dunky, P. Niemz, Holzwerkstoffe and Leime, Springer 2002, pages 251 to 259 (UF resins) and pages 303 to 313 (MUF and UF with small amount of melamine, the latter also known as melamine-fortified UF resins (UFm)). Phenol-formaldehyde resins (PF resins) are also suitable formaldehyde resins.

Preferred formaldehyde resins are polycondensates of compounds having at least one carbamido group, including those partly substituted by organic radicals, and formaldehyde.

Particularly preferred formaldehyde resins are urea-formaldehyde resins (UF resins), melamine-formaldehyde resins (MF resins) or melamine-containing urea-formaldehyde resins (MUF resins and UFm resins) and melamine-urea-phenol-formaldehyde resins (MUPF resins).

Very particularly preferred formaldehyde resins are urea-formaldehyde resins (UF resins) and melamine-formaldehyde resins (MUF resins and UFm resins), for example Kaurit® or Kauramin® glue types from BASF SE.

In addition to the described conventional formaldehyde resins having a very high molar formaldehyde:amino group ratio, it is also possible to use formaldehyde resins having a lower molar formaldehyde:amino group ratio.

Such suitable formaldehyde resins, in particular aminoplast resins, are polycondensates of compounds having at least one amino group, including those partly substituted by organic radicals, and aldehyde, in which the molar ratio of aldehyde to amino group optionally partly substituted by organic radicals is in the range from 0.3 to 1.0, preferably from 0.3 to 0.6, particularly preferably from 0.4 to 0.5.

Further suitable formaldehyde resins of this type, in particular aminoplast resins, are polycondensates of compounds having at least one amino group-NH₂ and formaldehyde, in which the molar ratio of formaldehyde to —NH₂ group is in the range from 0.3 to 1.0, preferably from 0.3 to 0.6, particularly preferably from 0.4 to 0.5.

Further suitable formaldehyde resins of this type, in particular aminoplast resins, are urea-formaldehyde resins (UF resins) or melamine-containing urea-formaldehyde resins (MUF resins and UFm resins), in which the molar ratio of formaldehyde to —NH₂ group is in the range from 0.3 to 1.0, preferably from 0.3 to 0.6, particularly preferably from 0.4 to 0.5.

Further suitable formaldehyde resins of this type, in particular aminoplast resins, are urea-formaldehyde resins (UF resins), in which the molar ratio of formaldehyde to —NH₂ group is in the range from 0.3 to 1.0, preferably from 0.3 to 0.6, particularly preferably from 0.4 to 0.5.

The abovementioned conventional formaldehyde resins, in particular aminoplast resins, having a lower formaldehyde content are usually used in liquid form, in general suspended in a liquid suspending medium, preferably in aqueous suspension, but can also be used as a solid.

The solids content of the formaldehyde resin suspensions, preferably aqueous suspension, is usually from 25 to 90% by weight, preferably from 50 to 70% by weight.

The solids content of an aminoplast resin as a representative of formaldehyde resins in aqueous suspension can be determined, for example, according to Günter Zeppenfeld, Dirk Grunwald, Klebstoffe in der Holz- and Möbelindustrie, 2^{nd} edition, DRW-Verlag, page 268. For determining the solids content of aminoplast glues, 1 g of aminoplast glue is accurately weighed into a weighing dish, finely distributed on the bottom and dried for 2 hours at 120° C. in a drying oven. After thermostating at room temperature in a desiccator, the residue is weighed and is calculated as a percentage of the weight taken.

The aminoplast resins are prepared by known processes (cf. abovementioned Ullmann literature “Aminoplaste” and “Amino Resins”, and abovementioned literature Dunky et al.) by reacting compounds containing carbamido groups, preferably urea and/or melamine, with the aldehydes, preferably formaldehyde, in the desired molar carbamido group: aldehyde ratios, preferably in water as a solvent.

The desired molar ratio of aldehyde, preferably formaldehyde, to amino group optionally partly substituted by organic radicals can also be established by adding monomers carrying —NH₂ groups to prepared, preferably commercial, aminoplast resins having a relatively high formaldehyde content. Monomers carrying NH₂ groups are preferably urea and melamine, particularly preferably urea.

An optional component of the binder (a) (hereinafter referred to as (a2)) and a mandatory component of binder (b) (hereinafter referred to as (II)) is an organic isocyanate having at least two isocyanate groups.

All organic isocyanates known to the person skilled in the art, preferably those known for the production of woodbase materials or polyurethanes, can be used as suitable organic isocyanate (a2) and/or (II). Such organic isocyanates and their preparation and use are described, for example in Becker/Braun, Kunststoff Handbuch, 3^{rd} revised edition, volume 7 “Polyurethane”, Hanser 1993, pages 17 to 21, pages 76 to 88 and pages 665 to 671.

Preferred organic isocyanates (a2) and/or (II) are oligomeric isocyanates having 2 to 10, preferably 2 to 8, monomer units and on average at least one isocyanate group per monomer unit.

A particularly preferred organic isocyanate (a2) and/or (II) is the oligomeric organic isocyanate PMDI (“Polymeric Methylenediphenylene diisocyanate”) which is obtainable by condensation of formaldehyde with aniline and phosgenation of the isomers and oligomers formed in the condensation (cf. for example Becker/Braun, Kunststoff Handbuch, 3^{rd} revised edition, volume 7 “Polyurethane”, Hanser 1993, page 18, last paragraph to page 19, second paragraph and page 76, fifth paragraph).

The organic isocyanate (a2) and/or (II) can also be present in aqueous-emulsifiable form, as obtainable for example by (i) adding emulsifiers, for example polyethylene glycols, glue, polyvinylpyrrolidone, polyacrylamides, or (ii) by modifying with monofunctional polyethylene oxide derivatives or by adding phosphoric or sulfonic acids.

In the context of the present invention, very suitable PMDI products (a2) and/or (II) are the products of the LUPRANAT® series of BASF SE, in particular LUPRANAT® M 20 FB of BASF Polyurethanes GmbH or the water-emulsifiable form of the ELASTAN® series of BASF Polyurethanes GmbH.

It is also possible to use mixtures of the organic isocyanates described, the mixing ratio not being critical on the basis of current knowledge.

The binder (a) may comprise the components (a1) and (a2) in all mixing ratios or alone.

In a preferred embodiment, the binder (a) comprises only the component (a1), preferably an aminoplast resin, particularly preferably a UF resin and/or MUF resin and/or UFm resin.

In a further preferred embodiment, the binder (a) comprises only the component (a2), preferably PMDI.

In a further preferred embodiment, the binder (a) comprises the component (a1), preferably an aminoplast, particularly preferably a UF resin and/or UFm resin and/or MUF resin, in the range from 70 to 99.9% by weight, and the component (a2), preferably PMDI, in the range from 0.1 to 30% by weight, based in each case on the sum of (a1) and (a2) of the pure undiluted substances.

In a very particularly preferred embodiment, the binder (a) comprises a UF resin in the range from 70 to 99.9% by weight and PMDI in the range from 0.1 to 30% by weight, based in each case on the sum of (a1) and (a2) of the pure, undiluted substances.

The binders (a1) and (a2) can be used in an already mixed form, but it is also possible to bring the binders (a1) and (a2), as a rule initially unmixed, into contact with the lignocellulose-containing particles, usually in separate steps.

The total amount of the binder (a1), preferably of the UF resin, as pure, undiluted substance, based on the dry mass of the lignocellulose-containing particles, preferably wood particles, is in the range from 3 to 50% by weight, preferably from 5 to 15% by weight, particularly preferably from 6 to 12% by weight.

The total amount of the binder (a2), preferably of the PMDI, as pure, undiluted substance, based on the dry mass of the lignocellulose-containing particles, preferably wood particles, is in the range from 0.5 to 30% by weight, preferably from 1 to 10% by weight, particularly preferably from 2 to 6% by weight.

Where the binder (a) is composed of (a1) and (a2), the total amount of the binder (a), as pure undiluted substance, based on the dry mass of the lignocellulose-containing particles, preferably wood particles, is in the range from 0.5 to 30% by weight, preferably from 1 to 15% by weight, particularly preferably from 2 to 12% by weight.

The binder (b) comprises:

An aqueous component (I) comprising
(i) a polymer A which is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2),
   optionally
(ii) a low molecular weight crosslinking agent having at least two functional groups which are selected from the group consisting of hydroxyl, carboxyl and derivatives thereof, primary, secondary and tertiary amine, epoxy, aldehyde,
   an organic isocyanate having at least two isocyanate groups as component (II)
   and, optionally, a component (III) as an aqueous dispersion comprising one or more polymer(s) M, which is composed of the following monomers:
a) from 0 to 50% by weight of at least one ethylenically unsaturated monomer, which comprises at least one epoxide group and/or at least one hydroxyalkyl group (monomer(s) M1) and
b) from 50 to 100% by weight of at least one further ethylenically unsaturated monomer which differs from the monomers M1 (monomer(s) M2)
   and, optionally, customary additives as component (IV),
   and the binder (b) optionally comprises a formaldehyde scavenger.

The polymer A is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2).

The preparation of polymers A is familiar to the person skilled in the art and is effected in particular by free radical solution polymerization, for example in water or in an organic solvent (cf. for example A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

Suitable monomers A1 are in particular α,β-monoethylenically unsaturated mono- and dicarboxylic acids having three to six carbon atoms, the possible anhydrides thereof and the water-soluble salts thereof, in particular the alkali metal salts thereof, such as, for example, acrylic acid, methacrylic acid, maleic acid, fumaric acid, itaconic acid, citraconic acid, tetrahydrophthalic acid, or the anhydrides thereof, such as, for example, maleic anhydride, and the sodium or potassium salts of the above-mentioned acids. Acrylic acid, methacrylic acid and/or maleic anhydride are particularly preferred, acrylic acid and the binary combinations of acrylic acid and maleic anhydride or acrylic acid and maleic acid being especially preferred.

Suitable monomer(s) A2 are ethylenically unsaturated compounds which can be subjected to free radical copolymerization in a simple manner with monomer(s) A1, for example ethylene, C₃-C₂₄-α-olefins, such as propene, 1-hexene, 1-octene, 1-decene; vinylaromatic monomers, such as styrene, α-methylstyrene, o-chlorostyrene, or vinyltoluenes; vinyl halides, such as vinyl chloride or vinylidene chloride; esters of vinyl alcohol and monocarboxylic acids having 1 to 18 carbon atoms, such as vinyl acetate, vinyl propionate, vinyl n-butyrate, vinyl laurate and vinyl stearate; esters of α,β-mono-ethylenically unsaturated mono- and dicarboxylic acids, preferably having 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate; nitriles of α,β-monoethylenically unsaturated carboxylic acids, such as acrylonitrile, methacrylonitrile, fumaronitrile, maleonitrile, and conjugated C₄₋₈-dienes, such as 1,3-butadiene (butadiene) and isoprene. Said monomers form as a rule the main monomers which, based on the total amount of monomers A2, together account for a proportion of ≧50% by weight, preferably ≧80% by weight and particularly preferably ≧90% by weight or even the total amount of the monomers A2. As a rule, these monomers have only moderate to low solubility in water under standard conditions of temperature and pressure (20° C., 1 atm (absolute)).

Further monomers A2, which however have a high water solubility under the abovementioned conditions, are those which comprise either at least one sulfo group and/or the corresponding anion thereof or at least one amino, amido, ureido or N-heterocyclic group and/or the ammonium derivatives thereof which are protonated or alkylated on the nitrogen. Acrylamide and methacrylamide and furthermore vinyl-sulfonic acid, 2-acrylamido-2-methylpropanesulfonic acid, styrenesulfonic acid and the water-soluble salts thereof and N-vinylpyrrolidone; 2-vinylpyridine, 4-vinylpyridine; 2-vinylimidazole; 2-(N,N-dimethylamino)ethyl acrylate, 2-(N,N-dimethylamino)ethyl methacrylate, 2-(N,N-diemethylamino)ethyl acrylate, 2-(N,N-diethylamino)ethyl methacrylate, 2-(N-tert.-butylamino)ethyl methacrylate, N-(3-N′,N′-dimethylamino-propyl)methacrylamide and 2-(1-imidazolin-2-onyl)ethyl methacrylate may be mentioned by way of example.

Usually, the abovementioned water-soluble monomers A2 are present only as modifying monomers in amounts≦10% by weight, preferably ≦5% by weight and particularly preferably ≦3% by weight, based on the total amount of monomers A2.

Further monomers A2 which usually increase the internal strength of the films of a polymer matrix usually have at least one epoxy, hydroxyl, N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two noncojugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are C₁-C₈-hydroxyalkyl esters of methacrylic acid and of acrylic acid, such as n-hydroxyethyl, n-hydroxypropyl or n-hydroxybutyl acrylate and methacrylate, and compounds such as diacetoneacrylamide and acetylacetoxyethyl acrylate or methacrylate.

Frequently, the abovementioned crosslinking monomers A2 are used in amounts of ≦10% by weight, but preferably in amounts of ≦5% by weight, based in each case on the total amount of monomers A2. Particularly preferably, however, no such crosslinking monomers A2 at all are used for the preparation of the polymer A.

According to the invention, the proportion of monomers A2 which is incorporated in the form of polymerized units in the polymer A is advantageously≦10% by weight or ≦5% by weight.

Particularly advantageously, the polymer A comprises no monomers A2 at all incorporated in the form of polymerized units.

Preferred polymers A are obtainable by free radical solution polymerization of only monomers A1, particularly preferably from 65 to 100% by weight, very particularly preferably from 70 to 90% by weight, of acrylic acid with particularly preferably from 0 to 35% by weight, very particularly preferably from 10 to 30% by weight, of maleic acid or maleic anhydride.

Advantageously, polymer A has a weight average molecular weight Mw in the range from 1000 g/mol to 500 000 g/mol, preferably from 10 000 g/mol to 300 000 g/mol, particularly preferably from 30 000 g/mol to 120 000 g/mol.

Establishing the weight average molecular weight Mw in the preparation of polymer A is familiar to the person skilled in the art and is advantageously effected by free radical aqueous solution polymerization in the presence of free radical chain-transfer compounds, the so-called free radical chain regulators. The determination of the weight average molecular weight Mw is also familiar to the person skilled in the art and is effected, for example, by means of gel permeation chromatography.

Suitable commercial products for polymers A are, for example, the Sokalan® products of BASF SE, which are based, for example, on acrylic acid and/or maleic acid. Further suitable polymers are described in WO 99/02591 A.

The component (I) optionally comprises a low molecular weight crosslinking agent (ii) having at least two functional groups which are selected from the group consisting of hydroxyl, carboxyl and derivatives thereof, primary, secondary and tertiary amine, epoxy, aldehyde.

Suitable crosslinking agents of this type are those having a (weight-average) molecular weight in the range from 30 to 10 000 g/mol. The following may be mentioned by way of example: alkanolamines, such as triethanolamine; carboxylic acids, such as citric acid, tartaric acid, butanetetracarboxylic acid; alcohols, such as glucose, sucrose or other sugars, glycerol, glycol, sorbitol, trimethylolpropane; epoxides, such as bisphenol-A or bisphenol-F and also resins based thereon and further polyalkylene oxide glycidyl ethers or trimethylolpropane triglycidyl ether. In a preferred embodiment of the invention, the molecular weight of the low molecular weight crosslinker (ii) used is in the range from 30 to 4000 g/mol and more preferably in the range from 30 to 500 g/mol.

Polymer M is composed of the following monomers:
a) from 0 to 50% by weight of at least one ethylenically unsaturated monomer which comprises at least one epoxide group and/or at least one hydroxyalkyl group (monomer(s) M1) and
b) from 50 to 100% by weight of at least one further ethylenically unsaturated monomer which differs from the monomers M1 (monomer(s) M2).

Polymer M is obtainable by free radical emulsion polymerization of the corresponding monomers M1 and/or M2 in an aqueous medium. Polymer M may be present in a single-phase form or multiphase form, and can have a core/shell morphology.

The procedure for free radical emulsion polymerizations of ethylenically unsaturated monomers in an aqueous medium has been described before many times and is therefore sufficiently well known to the person skilled in the art (cf. for example: Emulsion Polymerisation in Encyclopedia of Polymer Science and Engineering, vol. 8, page 659 et seq. (1987); D. C. Blackley, in High Polymer Latices, vol. 1, page 35 et seq. (1966); H. Warson, The Applications of Synthetic Resin Emulsions, chapter 5, page 246 et seq. (1972); D. Diederich, Chemie in unserer Zeit 24, pages 135 to 142 (1990); Emulsion Polymerisation, Interscience Publishers, New York (1965); DE-A 40 03 422 and Dispersionen synthe-tischer Hochpolymerer, F. Holscher, Springer-Verlag, Berlin (1969)).

The free radical aqueous emulsion polymerization reactions are usually effected in such a way that the ethylenically unsaturated monomers are dispersed with a concomitant use of dispersants in an aqueous medium in the form of monomer droplets and polymerized by means of a free radical polymerization initiator.

Suitable monomer(s) M1 are in particular glycidyl acrylate and/or glycidyl methacrylate and hydroxyalkyl acrylates and methacrylates having C₂- to C₁₀-hydroxyalkyl groups, in particular C₂- to C₄-hydroxyalkyl groups and preferably C₂- and C₃-hydroxyalkyl groups, for example 2-hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate. One or more, preferably one or two, of the following monomers M1 are particularly advantageously used: 2-hydroxyethyl acrylate, 2-hydroxyethyl methacrylate, glycidyl acrylate, glycidyl methacrylate.

According to the invention, it is possible, optionally, initially to take a portion or the total amount of monomers M1 in the polymerization vessel. However, it is also possible to meter in the total amount or any remaining amount of monomers M1 during the polymerization reaction. The total amount or any remaining amount of monomers M1 can be metered into the polymerization vessel batchwise in one or more portions or continuously at constant or varying flow rates. Particularly advantageously, the metering of the monomers M1 is effected during the polymerization reaction continuously at constant flow rates, in particular as a constituent of an aqueous monomer emulsion.

Suitable monomer(s) M2 are in particular ethylenically unsaturated compounds which can undergo free radical copolymerization in a simple manner with monomer(s) M1, for example ethylene, vinylaromatic monomers, such as styrene, α-methyl styrene, o-chlorostyrene or vinyltoluenes; vinyl halides, such as vinyl chloride or vinylidine chloride; esters of vinyl alcohol and monocarboxylic acids having 1 to 18 carbon atoms, such as vinyl acetate, vinyl propionate, vinyl n-butyrate, vinyl laurate and vinyl stearate; esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate; nitriles of α,β-monoethylenically unsaturated carboxylic acids, such as acrylonitrile, methacrylonitrile, fumaronitrile, maleonitrile, and conjugated C₄₋₈-dienes, such as 1,3-butadiene (butadiene) and isoprene. Said monomers form as a rule the main monomers which, based on the total amount of monomers M2, together account for a proportion of ≧50% by weight, preferably ≧80% by weight and in particular ≧90% by weight. As a rule, these monomers have only moderate to low solubility in water under standard conditions of temperature and pressure (20° C., 1 atm (absolute)).

Monomers M2 which have a high water solubility under the abovementioned conditions are those which comprise either at least one acid group and/or the corresponding anion thereof or at least one amino, amido, ureido or N-heterocyclic group and/or the ammonium derivatives thereof which are protonated or alkylated on the nitrogen. α,β-Monoethylenically unsaturated mono- and dicarboxylic acids having 3 to 6 carbon atoms and the amides thereof, such as, for example, acrylic acid, methacrylic acid, maleic acid, fumaric acid, itaconic acid, acrylamide and methacrylamide, and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethyl-amino)ethyl methacrylate, 2-(N-tert.-butylamino)ethyl methacrylate, N-(3-N′,N′-dimethylaminopropyl)methacrylamide, 2-(1-imidazolin-2-onyl)ethyl methacrylate and ureido methacrylate may be mentioned by way of example. Usually, the abovementioned water-soluble monomers M2 are present only as modifying monomers in amounts of ≦10% by weight, preferably ≦5% by weight and particularly preferably ≦3% by weight, based on the total amount of monomers M2.

Monomers M2, which usually increase the internal strength of the films of a polymer matrix, usually have at least one N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of importance in this context are compounds such as diacetoneacrylamide and acetylacetoxyethyl acrylate or methacrylate. Frequently, the abovementioned crosslinking monomers M2 are used in amounts of ≦10% by weight, preferably in amounts of ≦5% by weight and particularly preferably in amounts of ≦3% by weight, based in each case on the total amount of monomers A2. Frequently, however, no such crosslinking monomers M2 at all are used.

According to the invention, it is possible, optionally, initially to take a portion or the total amount of monomers M2 in the polymerization vessel. However, it is also possible to meter in the total amount or any remaining amount of monomers M2 during the polymerization reaction. The total amount or any remaining amount of monomers M2 can be metered into the polymerization vessel batchwise in one or more portions or continuously at constant or varying flow rates. Particularly advantageously, the metering of the monomers M2 during the polymerization reaction is effected continuously at constant flow rates, in particular as a constituent of an aqueous monomer emulsion.

For the preparation of the aqueous dispersion of the component (II), frequently dispersants are concomitantly used which keep both the monomer droplets and the polymer particles obtained by the free radical polymerization dispersed in the aqueous phase and thus ensure the stability of the aqueous polymer composition produced. Both the protective colloids usually used for carrying out free radical aqueous emulsion polymerizations and emulsifiers are suitable as such.

Suitable protective colloids are, for example, polyvinyl alcohols, cellulose derivatives or copolymers comprising vinylpyrrolidone or acrylic acid, for example those defined herein as component I(i). A detailed description of further suitable protective colloids is to be found in Houben-Weyl, Methoden der organischen Chemie, volume XIV/1, Makromolekulare Stoffe, pages 411 to 420, Georg-Thieme-Verlag, Stuttgart, 1961.

Of course, mixtures of emulsifiers and/or protective colloids can also be used. Frequently, exclusively emulsifiers whose relative molecular weights in contrast to the protective colloids are usually below 1000 are used as dispersants. They may be anionic, cationic or nonionic. When mixtures of surface-active substances are used, the individual components must of course be compatible with one another, which in case of doubt can be checked by means of a few preliminary experiments. In general, anionic emulsifiers are compatible with one another and with nonionic emulsifiers. The same also applies to cationic emulsifiers, while anionic and cationic emulsifiers are generally not compatible with one another.

Customary emulsifiers are, for example, ethoxylated mono-, di- and trialkylphenoles (degree of EO: 3 to 50, alkyl radical: C₄ to C₁₂), ethoxylated fatty alcohols (degree of EO: 3 to 50; alkyl radical: C₈ to C₃₆) and alkali metal and ammonium salts of alkylsulfates (alkyl radical: C₈ to C₁₂), of sulfuric monoesters of ethoxylated alkanols (degree of EO: 3 to 30, alkyl radical: C₁₂ to C₁₈) and of ethoxylated alkylphenoles (degree of EO: 3 to 50, alkyl radical: C₄ to C₁₂), of alkanesulfonic acids (alkyl radical: C₁₂ to C₁₈) and of alkylarylsulfonic acids (alkyl radical: C₉ to C₁₈). Further suitable emulsifiers are to be found in Houben-Weyl, Methoden der organischen Chemie, volume XIV/1, Makromolekulare Stoffe, pages 192 to 208, Georg-Thieme-Verlag, Stuttgart, 1961.

Nonionic and/or anionic emulsifiers are preferably used for the process according to the invention.

As a rule, the amount of dispersant, in particular emulsifiers, used is from 0.1 to 5% by weight, preferably from 1 to 3% by weight, based in each case on the total amount of the monomer mixture M. In the event that protective colloids are used as sole dispersing auxiliaries, the amount used will be distinctly higher; the amount used is typically from 5% to 40% by weight of dispersing auxiliary, preferably from 10% to 30% by weight, all based on the total weight of the monomer mixture M.

According to the invention, it is possible, optionally, initially to take a portion or the total amount of dispersant in the polymerization vessel. However, it is also possible to meter in the total amount or any remaining amount of dispersant during the polymerization reaction. The total amount or any remaining amount of dispersant can be metered into the polymerization vessel batchwise in one or more portions or continuously at constant or varying flow rates. Particularly advantageously, the metering of the dispersants during the polymerization reaction is effected continuously at constant flow rates, in particular as a constituent of an aqueous monomer emulsion.

Preferred polymers M comprise a) from 0.01 to 50% by weight of at least one ethylenically unsaturated monomer which comprises at least one epoxide group and/or at least one hydroxyalkyl group (monomer(s) M1) and b) from 50 to 99.99% by weight of at least one further ethylenically unsaturated monomer which differs from the monomers M1 (monomer(s) M2).

Particularly preferred polymers M of this type are obtainable by free radical solution polymerization of from 10 to 30% by weight, preferably from 15 to 22% by weight, of esters of acrylic acid and/or methacrylic acid with C₁₋₈-alcohols—preferably methanol, n-butanol, 2-ethylhexanol—with from 40 to 70% by weight, preferably from 55 to 65% by weight, of styrene and of from 5 to 50% by weight, preferably from 20 to 30% by weight, of 2-hydroxyethyl acrylate and/or 2-hydroxyethyl methacrylate and/or glycidyl acrylate and/or glycidyl methacrylate, the sum of the components being 100% by weight.

Further preferred polymers M comprise no monomer(s) M1 and are obtainable by free radical solution polymerization of from 80 to 99% by weight, preferably from 85 to 95% by weight, of esters of acrylic acid and/or methacrylic acid with C₁₋₈-alcohols—preferably methanol, n-butanol, 2-ethylhexanol—with from 0 to 5% by weight, preferably from 1 to 3% by weight, of ureido methacrylate and of from 0.5 to 5% by weight, preferably from 1 to 4% by weight, of α,β-monoethylenically unsaturated mono- and dicarboxylic acids having 3 to 6 carbon atoms—preferably acrylic acid, methacrylic acid—and/or amides of these acids, the sum of the components being 100% by weight.

Further preferred polymers M are obtainable by using dispersing auxiliaries based on poly(acrylic acid)s as described in EP 1240205 A or DE19991049592 A.

Such polymers preferably have a core/shell morphology (isotropic distribution of the phases, for example in the form of onion skins) or a Janus morphology (anisotropic distribution of the phases).

By targeted variation of type and amount of monomers M1 and M2, it is possible for the person skilled in the art, according to the invention, to prepare aqueous polymer compositions whose polymers M have a glass transition temperature T_{g} or a melting point in the range from −60 to 270° C.

Advantageously, the glass transition temperature T_{g} of the polymer M is in the range from 10° C. to 120° C. and preferably in the range from 30° C. to 90° C.

The glass transition temperature T_{g}, is understood as meaning the limit of the glass transition temperature toward which the glass transition temperature tends with increasing molecular weight, according to G. Kanig (Kolloid-Zeitschrift & Zeitschrift für Polymere, vol. 190, page. 1, equation 1). The glass transition temperature or the melting point is determined by the DSC method (Differential Scanning calorimetry, 20 K/min, midpoint measurement, DIN 53765).

The T_{g} values for the homopolymers of most monomers are known and are listed, for example, in Ullmann's Encyclopedia of Industrial Chemistry, part 5, vol. A21, page 169, VCH Weinheim, 1992; further sources of glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed, J. Wiley, New York 1989).

The components (I) and (III) according to the invention usually have polymer solids contents (total amount of polymer A or total amount of polymer M) of ≧10 and ≦70% by weight, frequently≧20 and ≦65% by weight and often≧40 and ≦60% by weight, based on the respective aqueous component (I) or (II).

The number average particle diameter (cumulant z average) of the polymer M, determined via quasielastic light scattering (ISO standard 13321), in the aqueous component (III) is as a rule from 10 to 2000 nm, frequently from 20 to 1000 nm and often from 50 to 700 nm or from 80 to 400 nm.

The components of the binder (b), preferably the components (I) and (III), can be used ready-mixed, but it is also possible for the components of the binder (b) to be in a generally initially unmixed state when they are brought into contact with the lignocellulose-containing particles, typically in separate steps.

The total amount of the components (I) and (III) of the binder (b) as a pure, undiluted substance, based on the dry mass of the lignocellulose-containing particles, preferably wood particles, is in the range from 0.5% to 50% by weight, preferably in the range from 0.75% to 12% by weight and more preferably in the range from 1% to 6% by weight.

The total amount of the component (I) of the binder (b) as a pure, undiluted substance, based on the dry mass of the lignocellulose-containing particles, preferably wood particles, is in the range from 0.5% to 30% by weight, preferably in the range from 1% to 10% by weight and more preferably in the range from 1.5% to 6% by weight.

The total amount of the component (III) of the binder (b) as a pure, undiluted substance, based on the dry mass of the lignocellulose-containing particles, preferably wood particles, is in the range from 0.5 to 30% by weight, preferably in the range from 0.75% to 10% by weight and more preferably in the range from 1 to 6% by weight.

The weight ratio of component (I):component (III) of the binder (b) as a pure, undiluted substance is in the range from 10:1 to 1:10 preferably 5:1 to 1:5 and more preferably 3:1 to 1:3.

The pH of the binder (b) is in the range from 0 to 5, preferably in the range from 2 to 4. The desired pH of the binder B arises as a rule by the combination of the components (I) and (III) and, optionally, component (IV) and/or formaldehyde scavenger.

The pH of the binder (b) at the place of action can, however, be adjusted to the desired value in the range from 0 to 5, preferably in the range from 2 to 4, in a customary manner by addition of inorganic or organic acids and/or salts thereof, for example mineral acids, such as sulfuric acid, hydrochloric acid, phosphorus-containing acids such as phosphoric acid, phosphorous acid or hypophosphorous acid and salts thereof, for example sodium phosphate, sodium phosphite, sodium hypophosphite; organic sulfonic acids, such as methanesulfonic acid, carboxylic acids, such as formic acid or acetic acid, or sodium formate, sodium acetate, sodium citrate, or inorganic or organic bases, for example sodium hydroxide (aqueous or as such), calcium oxide or calcium carbonate (in each case aqueous or as such) or ammonia, aqueous or as such.

In general, the ready-mixed binder (b) having the abovementioned pH ranges can be used. The desired pH—as described above—can, however, also be adjusted by applying the individual components of the binder (b) and the acids or bases described above separately to the lignocellulose-containing substrate. Through the choice of the pH of the components of the binder (b) and of the added acids or bases, the person skilled in the art can combine them so that the desired pH is established on the lignocellulose-containing substrate.

The term additive as component (IV) is to be understood as meaning all additives known to the person skilled in the art, for example waxes, paraffin emulsion, flame-retardant additives, wetting agents, salts, but also inorganic or organic acids and bases, for example mineral acids, such as sulfuric acid or nitric acid, phosphorus-containing acids such as phosphoric acid, phosphorous acid or hypophosphorous acid; organic sulfonic acids, such as methanesulfonic acid, carboxylic acids, such as formic acid or acetic acid, or inorganic or organic bases, for example sodium hydroxide (aqueous or as such), calcium oxide or calcium carbonate (in each case aqueous or as such) or ammonia, aqueous or as such. These additives can be added in an amount of from 0 to 20% by weight, preferably from 0 to 5% by weight, in particular from 0 to 2% by weight, based on the dry mass of the lignocellulose-containing particles, for example absolutely dry wood.

The lignocellulose-containing particles, preferably wood particles, particularly preferably wood chips or fibers, are coated with glue as a rule by bringing into contact with the binder (a) or (b). So-called glue application methods of this type are known for the production of conventional woodbase materials with customary aminoplast resins and are described, for example, in “Taschenbuch der Spanplatten Technik”, H.-J. Deppe, K. Ernst, 4^{th} edition, 2000, DRW—Verlag Weinbrenner GmbH & Co., Leinfelden-Echter-dingen, chapter 3.3.

The binder (a) or (b) can be brought into contact with the lignocellulose-containing particles, preferably wood particles, particularly wood chips or fibers, in various ways, preferably by spraying (a) or (b) onto the lignocellulose-containing particles. In the glue application, the binder (a) or (b) is usually used in such amounts as described above.

As far as the binder (b) is concerned, it is preferable for the component (II) not to be premixed with the further components (I) and/or (III) and/or (IV) when it is brought into contact with the lignocellulose-containing particles. The component (II) can be brought into contact with the lignocellulose-containing particles at a time before or after the other aforementioned components.

The binder (b) optionally comprises a formaldehyde scavenger. The binder (b) preferably comprises a formaldehyde scavenger if the binder (a) comprises a formaldehyde resin as described above.

Formaldehyde scavenger refers to chemical substances which as a rule have a free electron pair which reacts chemically with the formaldehyde, i.e. chemically binds the formaldehyde, as a rule virtually irreversibly. Such free electron pairs are present, for example, on the following functional groups of organic or inorganic compounds: primary, secondary and tertiary amino groups, hydroxyl group, sulfite group, amides, imides.

Examples of suitable formaldehyde scavengers are: ammonia, urea, melamine, organic C₁-C₁₀-amines, polymers which carry at least one amino group, such as polyamines, polyimines, polyureas, polylysines, polyvinylamine, polyethylenimine. Urea is a particularly preferred formaldehyde scavenger.

The amount of the formaldehyde scavengers in the binder (b) is in the range from 0.1 to 10% by weight, preferably from 0.5 to 7% by weight, based on the dry mass of the lignocellulose-containing particles, for example absolutely dry wood, and pure, undiluted formaldehyde scavenger.

In the multilayer lignocellulose-containing moldings of the present invention, at least one middle layer A) comprises expanded plastic particles and optionally at least one covering layer B) comprises expanded plastic particles.

For example, in a three-layered lignocellulose-containing molding according to the present invention, the middle layer A) comprises expanded plastic particles and optionally in this case at least one covering layer B) comprises expanded plastic particles.

Preferably, in the multilayer lignocellulose-containing moldings of the present invention, at least one middle layer A) comprises expanded plastic particles and the covering layers B) comprise practically no expanded plastic particles. For example, in a three-layered lignocellulose-containing molding according to the present invention, the middle layer A) comprises expanded plastic particles and in this case the covering layers B) comprise practically no expanded plastic particles.

Expanded plastic particles for the purposes of the present invention are porous particles of thermoplastic or thermoset plastics. Such expanded plastic particles generally comprise cell structures.

Suitable plastics underlying the expanded plastic particles are for example polyketones, polysulfones, polyoxymethylene, PVC (rigid and flexible), polycarbonates, polyisocyanurates, polycarbodiimides, polyacrylimides and polymethacrylimides, polyamides, polyurethanes, aminoplast resins and phenolic resins, styrene homopolymers (hereinafter also referred to as “polystyrene” or “styrene polymer”), styrene copolymers, C₂-C₁₀-olefin homopolymers, C₂-C₁₀-olefin copolymers and polyesters. The olefin polymers mentioned are preferably produced using the 1-alkenes, for example ethylene, propylene, 1-butene, 1-hexene, 1-octene.

Preference is given to expanded thermoplastic particles, such as polyketones, polysulfones, polyoxymethylene, PVC (rigid and flexible), polycarbonates, polyamides, polyurethanes, styrene homopolymers (hereinafter also referred to as “polystyrene” or “styrene polymer”), styrene copolymers, C₂-C₁₀-olefin homopolymers, C₂-C₁₀-olefin copolymers and polyesters.

A very suitable process for producing such expanded plastic particles, preferably expanded thermoplastic particles, can be carried out as follows: Compact plastic particles, preferably compact thermoplastic particles, comprising an expansion-capable medium (also called “blowing agent”) are expanded (often also referred to as “foamed”) by the action of heat energy or pressure change. The blowing agent expands in the process, the particles increase in size, and cell structures are formed. This expansion is generally carried out in customary foaming devices, often referred to as “prefoamers”. Such prefoamers can be fixed installations or alternatively be mobile. The expansion can be carried out in one or more stages. In general, in the one-stage process, the expandable plastic particles are expanded directly to the desired final size. In general, in the multi-stage process, the expandable plastic particles are first expanded to an intermediate size and then expanded in one or more further stages via a corresponding number of intermediate sizes to the desired final size.

Such expanded plastic particles, preferably expanded thermoplastic particles, typically have a bulk density in the range from 10 to 100 kg/m³, preferably in the range from 40 to 100 kg/m³, more preferably in the range from 45 to 80 kg/m³, and more particularly in the range from 50 to 70 kg/m³.

Such expanded plastic particles, preferably expanded thermoplastic particles, are generally obtained and used in the form of balls or beads having an average diameter in the range from 0.25 to 10 mm, preferably in the range from 1 to 8.5 mm and more particularly in the range from 1.2 to 7 mm.

Particularly preferred expanded thermoplastic particles are obtained from styrene homopolymer (hereinafter also simply referred to as “polystyrene”) and/or styrene copolymer; they are in what follows referred to as expanded styrene polymer or expanded styrene copolymer.

The starting material polystyrene and/or styrene copolymer can be produced by any polymerization process known to the person skilled in the art, see for example Ullmann's Encyclopedia, Sixth Edition, 2000 Electronic Release or Kunststoff-Handbuch 1996, Volume 4 “Polystyrol”, pages 567 up to 598, and suspension polymerization or extrusion processes are highly suitable.

The preparation of the expandable polystyrene and/or styrene copolymer is effected as a rule in a manner known per se by suspension polymerization or by means of extrusion processes.

In the suspension polymerization, styrene, if appropriate with addition of further comonomers, is polymerized in aqueous suspension in the presence of a customary suspension stabilizer by means of catalysts forming free radicals. A blowing agent and, optionally, further additives can be concomitantly initially taken in the polymerization or added to the batch in the course of the polymerization or after the end of the polymerization. The bead-like, expandable styrene polymers obtained, which are impregnated with blowing agent, are separated from the aqueous phase after the end of polymerization, washed, dried and screened.

In the extrusion process, a blowing agent is mixed into the polymer for example via an extruder, transported through a die plate and granulated under pressure to give particles or strands.

Any blowing agents known to the person skilled in the art and already mentioned above may be used as blowing agents for the preparation of the expandable polystyrene and/or styrene copolymer, for example aliphatic C₃- to C₁₀-hydrocarbons, such as propane, n-butane, isobutane, n-pentane, isopentane, neopentane, cyclopentane and/or hexane and isomers thereof, alcohols, ketones, esters, ethers or halogenated hydrocarbons.

The blowing agent is preferably selected from the group consisting of n-pentane, isopentane, neopentane and cyclopentane. A commercially available pentane isomer mixture comprising n-pentane and isopentane is particularly preferably used.

The content of blowing agent in the expandable polystyrene or styrene copolymer is in the range from 0.01 to 7% by weight, and when low blowing agent contents are desired, in the range from 0.01 to 4% by weight, preferably from 0.1 to 4% by weight, based in each case on the expandable polystyrene or styrene copolymer containing blowing agent.

The content of C₃- to C₁₋₁₀-hydrocarbons as blowing agent in the expandable polystyrene or styrene copolymer is in the range from 0.01 to 7% by weight, and when low blowing agent contents are desired, in the range from 0.01 to 4% by weight, preferably from 0.1 to 4% by weight, based in each case on the expandable polystyrene or styrene copolymer containing blowing agent.

The content of blowing agent, selected from the group consisting of n-pentane, isopentane, neopentane and cyclopentane, in the expandable polystyrene or styrene copolymer is in the range from 0.01 to 7% by weight, and when low blowing agent contents are desired, in the range from 0.01 to 4% by weight, preferably from 0.1 to 4% by weight, based in each case on the expandable polystyrene or styrene copolymer containing blowing agent.

The content of blowing agent, selected from the group consisting of n-pentane, isopentane, neopentane and cyclopentane, in the expandable polystyrene is in the range from 0.01 to 7% by weight, and when low blowing agent contents are desired, in the range from 0.01 to 4% by weight, preferably from 0.1 to 4% by weight, based on the expandable polystyrene containing blowing agent.

The styrene polymers or styrene copolymers may comprise additives, for example UV stabilizers, antioxidants, coating materials, water repellents, nucleating agents, plasticizers, flameproofing agents, soluble and insoluble inorganic and/or organic dyes, pigments and athermanous particles, such as carbon black, graphite or aluminum powder.

As described, styrene copolymers can also be used. Advantageously, these styrene copolymers have at least 50% by weight, preferably at least 80% by weight, of styrene incorporated in the form of polymerized units. Suitable comonomers are, for example, α-methylstyrene, styrenes halogenated on the nucleus, acrylonitrile, esters of acrylic or methacrylic acid of alcohols having 1 to 8 carbon atoms, N-vinylcarbazole, maleic acid(anhydride), (meth)acrylamides and/or vinyl acetate.

Advantageously, the polystyrene and/or styrene copolymer may comprise a small amount of a chain-branching agent incorporated in the form of polymerized units, i.e. of a compound having more than one double bond, preferably two double bonds, such as divinylbenzene, butadiene and/or butanediol diacrylate. The branching agent is generally used in amounts of from 0.0005 to 0.5 mol %, based on styrene.

Preferably, styrene polymers or styrene copolymers having a molecular weight in the range from 70 000 to 400 000 g/mol, particularly preferably from 190 000 to 400 000 g/mol, very particularly preferably from 210 000 to 400 000 g/mol, are used.

Mixtures of different styrene (co)polymers may also be used.

Very suitable styrene homopolymers or styrene copolymers are crystal-clear polystyrene (GPPS), high impact polystyrene (HIPS), anionically polymerized polystyrene or impact-resistant polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers or mixtures thereof or with polyphenylene ether (PPE).

Particularly preferably, a styrene homopolymer having a molecular weight in the range from 70 000 to 400 000 g/mol, particularly preferably from 190 000 to 400 000 g/mol, very particularly preferably from 210 000 to 400 000 g/mol, is used.

For the preparation of expanded polystyrene or expanded styrene copolymer, in general the expandable styrene homopolymers or expandable styrene copolymers described above are expanded (often also referred to as “foamed”) in a known manner by heating to temperatures above their softening point, for example by hot air or preferably steam and/or pressure change, as described, for example, in Kunststoff Handbuch 1996, volume 4 “Polystyrol”, Hanser 1996, pages 640 to 673, or U.S. Pat. No. 5,112,875.

The expandable polystyrene or expandable styrene copolymer is obtainable as a rule in a manner known per se by suspension polymerization or by means of extrusion processes as described above.

On expansion, the blowing agent expands, the polymer particles increase in size and cell structures form.

The expanded polystyrene or expanded styrene copolymer has a bulk density in the range from 10 to 100 kg/m³, preferably in the range from 45 to 100 kg/m³, more preferably in the range from 45 to 80 kg/m³ and more particularly in the range from 50 to 70 kg/m³.

The expanded polystyrene or expanded styrene copolymer is generally obtained and used in the form of balls or beads having an average diameter in the range from 0.25 to 10 mm, preferably in the range from 1 to 8.5 mm, more particularly in the range from 1.2 to 7 mm.

The expanded polystyrene or expanded styrene copolymer balls advantageously have a small surface area per volume, for example in the form of a spherical or elliptical particle.

The expanded polystyrene or expanded styrene copolymer balls are advantageously closed-cell. The proportion of open cells according to DIN-ISO 4590 is generally less than 30%.

The expanded plastic particles as described above, including preference ranges, preferably expanded thermoplastic particles as described above, including preference ranges, and more preferably expanded polystyrene or expanded styrene copolymer as described above, including preference ranges, may still comprise curatives and/or formaldehyde scavengers as described by way of example in European patent application 10155516.7 at page 5 line 4 to page 9 line 18 and example A2) for curatives and by way of example in European patent application 10155518.3 page 5 line 6 to page 9 line 12 and examples A2) to A3.2.2) for formaldehyde scavengers, which are each expressly incorporated herein by reference.

When formaldehyde scavenger-treated expanded plastic particles, preferably expanded polystyrene or expanded styrene copolymer as described above, including preference ranges, are used, it is generally the case that less formaldehyde scavenger is used in binder b) than in the variant in which the expanded plastic particles are not treated with formaldehyde scavenger.

The amount of expanded plastic particles as described above, including preference ranges, preferably expanded thermoplastic particles as described above, including preference ranges, and more preferably expanded polystyrene or expanded styrene copolymer as described above, including preference ranges, based on the lignocellulose-containing particles as described above, including preference ranges, preferably wood-containing particles of the middle layer or middle layers A) and optionally the covering layer or covering layers B), is in the range from 1% to 25% by weight, preferably in the range from 2% to 15% by weight and more preferably in the range from 3% to 12% by weight, in each case based on the corresponding layer A) or B) or the sum total of the corresponding layers A) or B).

The multilayer lignocellulose-containing moldings may have a regular or irregular three-dimensional shape. The following are examples of suitable desired shapes: all regular moldings, such as spheres, cylinders, cuboids, boards; all irregular shapes, such as irregular cavities, ornaments.

Preferred desired shapes are sheet-like, the form of a board being particularly preferred.

Further preferred multilayer lignocellulose-containing moldings comprise more than 70% by weight of lignocellulose-containing particles, preferably wood fibers, wood chips, flax fibers or flax shives.

The average density of the multilayer lignocellulose-containing moldings is usually in the range from 300 kg/m³ to 950 kg/m³, preferably from 350 kg/m³ to 850 kg/m³.

The average density of light multilayer lignocellulose-containing moldings is usually in the range from 300 kg/m³ to 600 kg/m³, preferably from 350 kg/m³ to 600 kg/m³ and more preferably from 400 kg/m³ to 500 kg/m³.

The multilayer lignocellulose-containing moldings according to the invention have a middle layer or a plurality of middle layers A) comprising lignocellulose-containing particles and a binder (a) and a covering layer or two covering layers (B) comprising lignocellulose-containing particles and a binder (b) and at least one middle layer A) comprising expanded plastic particles and, optionally, at least one covering layer B) comprising expanded plastic particles.

In the context of the invention, middle layer or middle layers is or are all layers which are not the outer layers.

The outer layer or the outer layers of the multilayer lignocellulose-containing moldings according to the invention are also referred to here as covering layer or covering layers.

Preferred multilayer lignocellulose-containing moldings according to the invention are sheet-like, preferably in the form of a board, comprising, for example, flax particles and/or wood particles, particularly preferably wood chips or wood fibers, as lignocellulose-containing particles, and have three layers; a middle layer A) and one covering layer B) each on the top and bottom thereof.

For the production of the multilayer lignocellulose-containing moldings, for example of the abovementioned, three-layer lignocellulose-containing moldings, the following binders are preferably used for the respective layers:

In a very suitable embodiment, the binder (b) comprises a component (III) but no low molecular weight crosslinker (ii), as will now be described by way of example under variants 1 and 2.

### Variant 1:

For the middle layer A) or the middle layers A), the binder (a) comprises only the component (a1), preferably an aminoplast resin, particularly preferably a UF resin and/or MUF resin.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises no further crosslinking component. The component (III) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

The binder (b) furthermore comprises the component (II) in the amounts defined above and a formaldehyde scavenger as defined above, in the amounts as defined there.

### Variant 2:

For the middle layer A) or the middle layers A), the binder (a) comprises the component (a1), preferably an aminoplast, particularly preferably a UF resin and/or MUF resin, and the component (a2), preferably PMDI, in the amounts defined above for the combination (a1) and (a2).

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) comprises no further crosslinking component. The component (III) of the binder (b) is an aqueous dispersion of a polymer M according to the invention, obtainable by free radical emulsion polymerization of from 50 to 65% by weight of styrene and from 5 to 15% by weight of methyl methacrylate, from 5 to 15% by weight of n-butyl acrylate, from 10 to 30% by weight of hydroxyethyl acrylate and from 2 to 20% by weight of glycidyl methacrylate in water, the sum of the monomers being 100% by weight.

The binder (b) furthermore comprises the component (II) in the amounts defined above and a formaldehyde scavenger as defined above, in the amounts as defined there.

In a further very suitable embodiment, the binder (b) comprises a low molecular weight crosslinker (ii) and no component (III), as will now be described by way of example under variants 3 to 5.

### Variant 3:

For the middle layer A) or the middle layers A), the binder (a) comprises only the component (a1), preferably an aminoplast resin, particularly preferably a UF resin and/or MUF resin.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) additionally comprises a crosslinker component (ii), preferably having more than two functional groups per crosslinker molecule, particularly preferably triethanolamine.

The binder (b) further comprises the component (II) in the amounts defined above and a formaldehyde scavenger as defined above, in the amounts as defined there.

### Variant 4:

For the middle layer A) or the middle layers A), the binder (a) comprises only the component (a2), preferably PMDI.

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) additionally comprises a crosslinker component (ii), preferably having more than two functional groups per crosslinker molecule, particularly preferably triethanolamine.

The binder (b) further comprises the component (II) in the above-defined amounts but no formaldehyde scavenger.

### Variant 5:

For the middle layer A) or the middle layers A), the binder (a) comprises the components (a1) and (a2), preferably PMDI.

For a covering layer B) or the two covering layers B), the binder (b) is used, but without the component (III); for example, the binder (b) comprises an aqueous solution of a polymer A according to the invention, obtainable by free radical solution polymerization of 70% by weight of acrylic acid and 30% by weight of maleic anhydride in water. The component (I) additionally comprises a crosslinker component (ii), preferably having more than two functional groups per crosslinker molecule, particularly preferably triethanolamine.

The binder (b) further comprises a component (II) in the above-defined amounts and a formaldehyde scavenger as defined above, in the amounts as defined there.

In a further highly suitable embodiment, the binder (b) comprises both a low molecular weight crosslinker (ii) and a component (III), as described hereinbelow by way of example under variant 6.

### Variant 6:

For the middle layer A) or the middle layers A), the binder (a) comprises the component (a1), preferably an amino resin, particularly preferably a UF resin and/or MUF resin, and/or the component (a2), preferably PMDI in the amounts defined above for the combination (a1) and (a2).

For a covering layer B) or the two covering layers B), the binder (b) is used; for example, the binder (b) comprises an aqueous solution of a polymer A according to the invention, obtainable by free radical solution polymerization of 70% by weight of acrylic acid and 30% by weight of maleic anhydride in water. The component (I) additionally comprises a crosslinker component (ii), preferably having more than two functional groups per crosslinker molecule, particularly preferably triethanolamine. The component (III) of the binder (b) is an aqueous dispersion of a polymer M according to the invention, obtainable by free radical emulsion polymerization in water of 50% to 65% by weight of styrene and 5% to 15% by weight of methyl methacrylate, 5% to 15% by weight of n-butyl acrylate, 10% to 30% by weight of hydroxyethyl acrylate and 2% to 20% by weight of glycidyl methacrylate, the sum total of the monomers being 100% by weight.

The binder (b) further comprises the component (II) in the above-defined amounts and a formaldehyde scavenger as defined above in the amounts as defined there.

The thickness of the multilayer lignocellulose-containing moldings, preferably the board-like moldings, according to the invention varies with the field of application and is generally in the range from 0.5 to 300 mm; preference is given to relatively thin board-like moldings having a thickness in the range from 4 to 100 mm and in particular in the range from 6 to 40 mm.

The thickness ratios of the layers of the multilayer lignocellulose-containing moldings according to the invention, preferably of the board-like moldings, are variable. Usually, the outer layers A), also referred to as covering layers, by themselves or in total, are thinner than the layer or layers of the middle layer(s) B).

The mass of the individual covering layer is usually in the range from 5 to 30% by weight, preferably from 10 to 25% by weight, of the total mass of the multilayer lignocellulose-containing molding according to the invention.

In the preferred multilayer lignocellulose-containing molding according to the invention, preferably the board-like molding, the thickness of the middle layer(s) B), based on the total thickness of the multilayer lignocellulose-containing molding according to the invention, preferably the board-like molding, is in the range from 20% to 99%, preferably from 50% to 99%, particularly preferably from 60% to 99%.

The multilayer lignocellulose-containing moldings according to the invention, preferably those in which the lignocellulose-containing particles are wood particles and/or flax particles, particularly preferably wood chips or wood fibers, or flax chips or flax shives, are produced in the customary manner, as described in “Taschenbuch der Spanplatten Technik” H.-J. Deppe, K. Ernst, 4^{th} edition, 2000, DRW—Verlag Weinbrenner GmbH & Co., Leinfelden-Echterdingen, chapter 3.5.

Usually, first lignocellulose-containing particles, for the middle layer(s) A) and the covering layer(s) B), for example wood or flax, preferably wood, for example in the form of fibers, chips, veneers or strands, as described above, are brought into contact (also referred to as “glue-coated”) with the respective binder (a) (for the middle layer(s) A)) or (b) (for the covering layer(s) B)).

The glue-coating can take place before, during or after addition of the expanded plastic particles as described above, including preference ranges, preferably expanded thermoplastic particles as described above, including preference ranges, and more preferably expanded polystyrene or expanded styrene copolymer as described above, including preference ranges, to the lignocellulose-containing particles described above, including preference ranges, for the middle layer(s) A) and optionally the covering layer(s) B).

Preferably, the lignocellulose-containing particles and the expanded plastic particles are mixed and subsequently glue-coated, or the lignocellulose-containing particles and the expanded plastic particles are glue-coated in the course of mixing.

In a preferred embodiment, in the course of the above-described production of the multilayer lignocellulose-containing moldings of the present invention, the size of the expanded plastic particles as described above, including preference ranges, preferably expanded thermoplastic particles as described above, including preference ranges, and more preferably expanded polystyrene or expanded styrene copolymer as described above, including preference ranges, is harmonized with the size of the lignocellulose-containing particles described above, including preference ranges, for the middle layer(s) A) and optionally the covering layer(s) B), as described in WO 2008/046892 A2 (BASF SE), page 11 line 18 to page 12 line 11 and also the inventive examples described therein, which is hereby expressly incorporated herein by reference.

Thereafter, the lignocellulose-containing particles, for example wood or flax, preferably wood, for example in the form of fibers, chips, veneers or strands, glue-coated in this manner are placed in layers one on top of the other according to the desired sequence of the multilayer lignocellulose-containing molding to be produced and are pressed at elevated temperature by a customary method to give multilayer lignocellulose-containing moldings, preferably those in which the lignocellulose-containing particles are wood, for example in the form of fibers, chips, veneers or strands.

For this purpose, a fiber/chip mat is usually produced by sprinkling the lignocellulose-containing particles glue-coated in this manner, for example wood or flax—preferably wood, particularly preferably wood in the form of chips or fibers and also the expanded plastic particles as described above, including preference ranges, preferably expanded thermoplastic particles as described above, including preference ranges, and more preferably expanded polystyrene or expanded styrene copolymer as described above, including preference ranges,—onto a substrate and said mat is usually pressed at temperatures of from 80° C. to 250° C. and at pressures of from 5 to 50 bar to give multilayer lignocellulose-containing moldings according to the invention (cf. for example: “Taschenbuch der Spanplatten Technik” H.-J. Deppe, K. Ernst, 4^{th} edition, 2000, DRW—Verlag Weinbrenner GmbH & Co., Leinfelden-Echterdingen, pages 232-254. “MDF—Mitteldichte Faserplatten” H.-J. Deppe, K. Ernst, 1996, DRW—Verlag Weinbrenner GmbH & Co., Leinfelden-Echterdingen, pages 93-104).

The pressing times needed for board production are typically specified in “seconds per mm of board thickness”; or s/mm (often also referred to as pressing time factor). Multilayer lignocellulose-containing moldings according to the invention generally require pressing time factors of the kind known for the quick formaldehyde resins; a Siempelkamp laboratory press (dimensions 520 mm×520 mm) generally requires pressing time factors of 8 to 10 s/mm for moldings according to the invention, and also for boards produced using aminoplast-containing binders only; moldings produced with formaldehyde-free binders, for example products of the Acrodur® product range from BASF SE, require pressing time factors of more than 25 s/mm.

Particularly preferred multilayer lignocellulose-containing moldings according to the invention are all those which are produced from wood strips, for example veneer sheets or plywood sheets, or multilayer lignocellulose-containing moldings produced from wood chips, for example particle boards or OSB boards, and multilayer wood fiber materials, such as LDF, MDF and HDF boards.

Woodbase materials comprising formaldehyde-free binders are advantageously produced by the process according to the invention. Multilayer OSB boards, wood fiber boards and particle boards are preferred.

The present invention furthermore relates to the use of the multilayer lignocellulose-containing moldings according to the invention, preferably the multilayer wood-containing moldings according to the invention, for the production of pieces of furniture, of packaging materials, in house building, in drywall construction or in interior finishing, for example as laminate, insulating material, wall or ceiling element, or in motor vehicles.

The multilayer lignocellulose-containing moldings according to the invention show a greatly reduced emission of formaldehyde or virtually no emission of formaldehyde and are obtainable using very short pressing times.

The multilayer lignocellulose-containing moldings according to the invention moreover show increased peel strength for the covering layers, good transverse tensile strength and good moisture resistance.

### EXAMPLES

### 1. General

Amounts reported in % OD are weight percent based on the net mass of dry wood; OD stands for oven dry.

### 2. Methods of Measurement and Measured Results

Formaldehyde emissions were determined by the following test methods for woodbase materials (see also Bundesgesetzblatt 10/91, p. 488/489):
perforator value: DIN EN 120, ISO 12460-5;
test chamber method (option 2: 1 m³ chamber): DIN EN 717-1;

The mechanical properties of woodbase materials were evaluated by determining the following parameters:
peel strength to EN 311;
flexural strength to EN 310;
transverse tensile strength to EN 319;
water resistance or “swell values” to EN 317
and the “water absorption” method described hereinbelow.

Water absorption was determined similarly to DIN EN 317 except that it is not the thickness of the test specimen which is determined before and after 24 hour water immersion but its mass, by weighing. The water absorption WA of each test specimen as a percentage of the initial mass must be computed by the following formula: WA=100×(m2−m1)/ml.

In this formula:
m1 is the mass of the test specimen before water immersion, in grams (measured to 0.01 g)
m2 is the mass of the test specimen after water immersion, in grams (measured to 0.01 g)

Water absorption is reported to one decimal place.

Wood moisture was determined to DIN 52183.

### 3. Production of Multilayer Lignocellulose-Containing Moldings, in Particular the Production of 3-Layer Laboratory Chipboard

A certain amount of sprucewood chips (conditioned at 20° C. and 65% relative humidity) plus additives was resinated with the stated amounts of binder and binder components (see Table 1A) in a Lödige mixer. Resination was done in two steps, as explained below, when isocyanates were used as binders, otherwise unless otherwise stated in one step. The two-step resination mentioned was carried out as follows: the chips were first resinated with the Table 1A amount of component (II) (Lupranat® M 20 FB) and subsequently resinated with a mixture of the other components of binder (b) which are mentioned in Table 1A.

The resinated chips were measured for chip moisture content. The chips for covering and middle layers were resinated separately from each other.

Thereafter, the chips were manually formed into mats: first a covering layer, then the middle layer, already mixed with the Table 1A amount of expanded spherical styrene homopolymer having a bulk density of 50 g/l (referred to in Tables 1A and as KAURIT LIGHT 200), and finally the second covering layer in a mass ratio of 1 part of covering layer chips, then 4 parts of middle layer chips and again 1 part of covering layer chips.

The mat was hot-pressed at 210° C. using the molding pressure profile reported in the examples.

The properties of the three-layer lignocellulose-containing moldings produced in the tests were determined using the methods indicated above.

### 4. Binders and Binder Components

Fine binders (a) and (b) according to the present invention were used in the examples which follow, as described in the text which follows (including tables):

### Polymer A

Polymer A was obtained by free radical solution polymerization of 70% by weight of acrylic acid and 30% by weight of maleic anhydride in water. The weight average molecular weight Mw was 80 000 g/mol.

### Middle Layer Binders

The middle layer binders used were UF resins, trade name KAURIT® resins from BASF SE (KL=Kaurit® resin).

### Example 1

### PMDI as Co-Binder in the Covering Layer (Panel Density Approx. 400 kg/m³)

Several laboratory chipboard panels having dimensions of 56.5 cm*44.0 cm*16.0 mm were produced using different binder compositions as described above under 3. The target envelope density for the panels was 400 kg/m³.

In the middle layers of the chipboard panels, 10% by weight of the wood chips were replaced by the expanded styrene homopolymer characterized in item 3 (referred to as KAURIT LIGHT 200 in Table 1A).

Molding pressure profile: 50 s at 4 bar, 50 s at 2 bar, 40 s at 1 bar.

Table 1A reports the binder batches for the various board panels. Amount recitations without explicit units are by mass. The column headed “MS” identifies the binder for the middle layer, which is identical for all three batches. The columns headed “DS” identify the binders for the covering layers. Line H refers to an extra dose of water added to the binder: in case 1 this is extra water which was mixed into the resin, and in cases 2 and 3 this is the amount of water in which the solid fractions of the binder in lines D to G are dissolved.

TABLE 1A
production parameters

| | | | Batch | | | | | |
|---|---|---|---|---|---|---|---|---|
| | | | 1 | | 2 | | 3 | |
| | | | DS | MS | DS | MS | DS | MS |
| A | KL 347 [1] | % OD | 8.50 | 8.50 | | 8.50 | | 8.50 |
| B | Ammonium nitrate | % v/v | 1.00 | 4.00 | | 4.00 | | 4.00 |
| | solution (52%, curative) | of A | | | | | | |
| C | Hydrowax 560 (60%) | % OD | 0.03 | 0.05 | | 0.05 | | 0.05 |
| D | Polymer A (100%) | % OD | | | 3.59 | | 3.08 | |
| E | triethanolamine | % OD | | | 1.08 | | 0.92 | |
| F | urea (100%) | % OD | | | 2.33 | | 2.35 | |
| G | Hydrowax ® Q (50%) | % OD | | | 0.02 | | 0.02 | |
| | [4] | | | | | | | |
| H | Extra water | % OD | 0.50 | | 5.53 | | 5.30 | |
| J | Lupranat ® M20 FB | % OD | | | | | 1.00 | |
| | [2] | | | | | | | |
| K | Wood fraction replaced | % | | 10 | | 10 | | 10 |
| | by KAURIT Light 200 [3] | | | | | | | |

[1] An aqueous solution or dispersion of a urea-formaldehyde (UF) resin from BASF SE; dry resin content 65 to 70% by weight.
[2] Solvent-free highly reactive organic isocyanate product from BASF Polyurethane GmbH based on 4,4′-diphenylmethyl diisocyanate with higher-functional oligomers and isomers wherein the average functionality is 2.7 and the NCO content is 31.8 g/100 g (Lupranat ® M20 FB Technical Information dated May 2010).
[3] Expanded styrene homopolymer as described above under item 3.
[4] Hydrowax ® Q: a hydrophobicizing agent from Sasol based on paraffin, an aqueous emulsion, solids content 60% or 50%.

TABLE 1B
results

| | | Batch | | |
|---|---|---|---|---|
| | | 1 | 2 | 3 |
| Thickness | | | | |
| at testing | mm | 15.73 | 15.84 | 15.73 |
| Transverse tensile | | | | |
| strength V 20 | | | | |
| Density (n = 10) | kg/m³ | 400.57 | 396.94 | 407.97 |
| Transverse tensile strength | N/mm² | 0.48 | 0.31 | 0.43 |
| Broken in covering layer | of 10 | 0 | 8 | 0 |
| Swelling (50 * 50 mm) | | | | |
| Density (n = 10) | kg/m³ | 397.30 | 388.09 | 401.36 |
| Swelling after 24 h | % | 12.25 | 15.72 | 15.22 |
| Water absorption after 24 h | % | 132.42 | 148.65 | 137.50 |
| Peel strength | | | | |
| Peel strength, top (n = 5) | N/mm² | 0.64 | 0.35 | 0.52 |
| Peel strength, bottom (n = 5) | N/mm² | 0.54 | 0.27 | 0.62 |
| Flexural strength | | | | |
| Flexural strength, along | N/mm² | 4.91 | 5.95 | 6.81 |
| (n = 3) | | | | |
| Flexural strength, across | N/mm² | 6.78 | 5.57 | 5.08 |
| (n = 3) | | | | |
| Perforator value to EN120 | | | | |
| based on 6.5% wood moisture | mg HCHO/ | 8.75 | 4.40 | 5.39 |
| | 100 g OD | | | |
| | sample | | | |
| Formaldehyde emission via | | | | |
| 1 m³ chamber value | ppm | 0.346 | 0.143 | 0.126 |
| (EN 717-1) | | | | |

Batch 1 constitutes a clipboard panel produced with UF resin and expanded styrene homopolymer, as per WO/2008/046892 A.
Batches 2 and 3 are chipboard panels in which the covering layer was in each case produced without UF resin, while the inventive covering layer in panel 3 comprises an isocyanate.

Both panels 2 and 3, compared with panel 1, have significantly reduced formaldehyde emissions.

The mechanical properties in the case of panel 2, however, are worse than in the case of panel 1.

The inventive panel 3 comprises, in the covering layer binder, an isocyanate, significantly improving the mechanical properties of panel 3 while preserving low formaldehyde emission: this gives a reduction in 24 h swelling and water absorption and an increase in transverse tensile strength and peel strength.

Conclusion: the inventive component (II) as co-binder in the covering layer improves mechanical properties of chipboard panels with low formaldehyde emission and a low density of about 400 kg/m³.

### Example 2

### PMDI as Co-Binder in the Covering Layer (Panel Density about 500 kg/m³)

Several laboratory chipboard panels having dimensions of 56.5 cm*44.0 cm*16.0 mm were produced using different binder compositions as described above under 3. The target envelope density for the panels was 500 kg/m3.

In the middle layers of the chipboard panels, 10% by weight of the wood chips were replaced by the expanded styrene homopolymer characterized in item 3 (referred to as KAURIT LIGHT 200 in Table 1A and Table 2A).

Molding pressure profile: 50 s at 4 bar, 50 s at 2 bar, 40 s at 1 bar.

The chipboard panels of Example 2 are similar in their composition to Example 1, while the density of the produced chipboard panels in Example 2 is about 500 kg/m³.

The binder batches of the various panels for Example 2 correspond to those for Example 1 and therefore are described in Table 1A.

TABLE 2B
results

| | | Batch | | |
|---|---|---|---|---|
| | | 1 | 2 | 3 |
| Thickness | | | | |
| at testing | mm | 15.95 | 15.73 | 15.74 |
| Transverse tensile | | | | |
| strength V 20 | | | | |
| Density (n = 10) | kg/m³ | 499.74 | 457.14 | 482.43 |
| Transverse tensile strength | N/mm² | 0.71 | 0.38 | 0.65 |
| Broken in covering layer | of 10 | 0 | 8 | 0 |
| Swelling (50 * 50 mm) | | | | |
| Density (n = 10) | kg/m³ | 500.47 | 458.74 | 485.05 |
| Swelling after 24 h | % | 15.12 | 24.56 | 17.37 |
| Water absorption after 24 h | % | 101.71 | 135.94 | 114.85 |
| Peel strength | | | | |
| Peel strength, top (n = 4) | N/mm² | 0.90 | 0.63 | 1.08 |
| Peel strength, bottom (n = 4) | N/mm² | 0.88 | 0.57 | 0.78 |
| Flexural strength | | | | |
| Flexural strength, along | N/mm² | 9.55 | 9.99 | 10.60 |
| (n = 3) | | | | |
| Flexural strength, across | N/mm² | 11.10 | 8.69 | 10.43 |
| (n = 3) | | | | |
| Perforator value to EN120 | | | | |
| based on 6.5% wood moisture | mg HCHO/ | 8.80 | 5.20 | 4.90 |
| | 100 g OD | | | |
| | sample | | | |
| Formaldehyde emission via | | | | |
| 1 m³ chamber value | ppm | 0.362 | 0.127 | 0.119 |
| (EN 717-1) | | | | |

Batch 1 constitutes a clipboard panel produced with UF resin and expanded styrene homopolymer, as per WO/2008/046892 A.
Batches 2 and 3 are inventive light chipboard panels in which the covering layer was in each case produced without UF resin, while the inventive covering layer in panel 3 comprises an isocyanate.

Both panels 2 and 3, compared with conventional panel 1, have significantly reduced formaldehyde emissions.

The mechanical properties in the case of panel 2 are worse than in the case of panel 1.

The inventive panel 3 comprises, in the covering layer binder, an isocyanate, significantly improving the mechanical properties of panel 3 while preserving low formaldehyde emission: this gives a reduction in 24 h swelling and water absorption and an increase in transverse tensile strength and peel strength.

Conclusion: the inventive component (II) as co-binder in the covering layer improves mechanical properties of chipboard panels with low formaldehyde emission and a density of about 500 kg/m³.

1-15. (canceled)

16. A multilayer lignocellulose-containing molding comprising
A) a middle layer or a plurality of middle layers comprising lignocellulose-containing particles which is/are obtainable by using a binder (a) and
B) a covering layer or a plurality of covering layers comprising lignocellulose-containing particles which is/are obtainable by using a binder (b),
the binder (a) being selected from the group consisting of (a1) formaldehyde resins and (a2) an organic isocyanate having at least two isocyanate groups;
the binder (b) comprising the following components:
an aqueous component (I) comprising
(i) a polymer A which is composed of the following monomers:
a) from 70 to 100% by weight of at least one ethylenically unsaturated mono- and/or dicarboxylic acid (monomer(s) A1) and
b) from 0 to 30% by weight of at least one further ethylenically unsaturated monomer which differs from the monomers A1 (monomer(s) A2)
optionally
(ii) a low molecular weight crosslinking agent having at least two functional groups which are hydroxyl, carboxyl, derivatives thereof, primary amine, secondary amine, tertiary amine, epoxy, aldehyde, or
an organic isocyanate having at least two isocyanate groups as component (II)
and, optionally, a component (III), as an aqueous dispersion, comprising
one or more polymer(s) M which is/are composed of the following monomers:
a) from 0 to 50% by weight of at least one ethylenically unsaturated monomer which comprises at least one epoxide and/or at least one hydroxyalkyl group (monomer(s) M1) and
b) from 50 to 100% by weight of at least one further ethylenically unsaturated monomer which differs from the monomers M1 (monomer(s) M2)
and, optionally, additives as component (IV),
and at least one middle layer A) comprising expanded plastic particles and, optionally, at least one covering layer B) comprising expanded plastic particles,
and the binder (b) optionally comprises a formaldehyde scavenger.

17. The multilayer lignocellulose-containing molding according to claim 16, wherein the binder (b) comprises a low molecular weight crosslinker (ii) and no component (III).

18. The multilayer lignocellulose-containing molding according to claim 16, wherein the binder (b) comprises a component (III) but no molecular weight crosslinker (ii).

19. The multilayer lignocellulose-containing molding according to claim 16, wherein the binder (b) comprises both a low molecular weight crosslinker (ii) and a component (III).

20. The multilayer lignocellulose-containing molding according to claim 16, wherein the binder (b) comprises a formaldehyde scavenger.

21. The multilayer lignocellulose-containing molding according to claim 16, which is in the form of three layers, comprising a middle layer A) and two covering layers B).

22. The multilayer lignocellulose-containing molding according to claim 16, wherein the binder (a) is only a formaldehyde resin (a1).

23. The multilayer lignocellulose-containing molding according to claim 16, wherein the binder (a) is only an organic isocyanate having at least two isocyanate groups (a2).

24. The multilayer lignocellulose-containing molding according to claim 16, wherein the binder (a) comprises the component (a1) in the range from 70 to 99.9% by weight and the component (a2) in the range from 0.1 to 30% by weight, based in each case on the sum of (a1) and (a2) of the pure undiluted substances.

25. The multilayer lignocellulose-containing molding according to claim 16, wherein the binder (b) comprises the component (I) in the range from 30 to 90% by weight and the component (II) in the range from 10 to 70% by weight, based in each case on the sum of (I) and (II) of the pure undiluted substances.

26. The multilayer lignocellulose-containing molding according to claim 16, wherein the expanded plastic particles have a bulk density in the range from 10 to 100 kg/m³.

27. The multilayer lignocellulose-containing molding according to claim 16, in the form of a board.

28. A process for the production of the multilayer lignocellulose-containing molding as defined in claim 16, which comprises bringing the lignocellulose particles for the middle layer or the middle layers (A) into contact with the binder (a) and the expanded plastic particles, bringing the lignocellulose particles for the covering layer or the covering layers (B) into contact with the binder (b) and, optionally, the expanded plastic particles, arranging them in layers one on top of the other according to the desired sequence and pressing them at elevated temperature.

29. A process for the production of articles of all types and in the construction sector which comprises utilizing the multilayer lignocellulose-containing molding as defined in claim 16.

30. The process as claimed in claim 29, wherein articles is a piece of furniture, a furniture part, a packaging material, in house building or in interior finishing or in a motor vehicle.
